(19) United States
(12) Patent Application Publication
(10) Pub. No.: US 2012/0172095 A1
(43) Pub. Date: Jul. 5, 2012

(54) 2-WAY REMOTE KEYCHAIN LOCATOR

(76) Inventor: Landon McDaniel, Conway, AR (US)

(21) Appl. No.: 12/980,426

(22) Filed: Dec. 29, 2010

(51) Int. Cl. G08B 6/00; G08B 3/00; G08B 5/00; H04W 88/02

(52) U.S. Cl. 455/575.1; 340/286.01; 455/550.1; 340/328

(57) ABSTRACT

In one embodiment of the invention, an apparatus for locating devices comprises a two-way locator comprising a first locator removably coupled to a first item and a second locator coupled to a second item. The first locator is configured to transmit a first trigger signal, the second locator is configured to receive the first trigger signal, and the second locator is configured to generate at least one location indicator signal in response to the first trigger signal. The second locator is configured to transmit a second trigger signal, the first locator is configured to receive the second trigger signal, and the first locator is configured to generate at least one location indicator signal in response to the second trigger signal.

### TECHNICAL FIELD

Embodiments of the invention relate generally to a two-way locator for locating devices. The devices can be, for example, without limitations, a portable communication device (e.g., phone) and a key or keys.

### BACKGROUND

Typically, almost every adult needs three items when leaving his/her residence for another destination: a wallet (or purse), one or more keys (home key and/or car key), and a portable communication device (e.g., a portable phone or cellular phone or a personal digital assistant). It is common for an individual to misplace these items in his/her residence, and it can be time consuming to find these misplaced items. Sometimes, these items are permanently lost and would need to be replaced if the individual is unable to locate these items.

Some individuals try to minimize misplacing items by placing the items in the same location. However any changes in an individual's routine, an emergency or unexpected situation, or other situations can still result in an item to still be misplaced by the individual. Therefore, attempts to locate these missing items are typically time consuming, often frustrating, and highly inconvenient for individuals.

The missing item may even be close in proximity to the individual but is hidden from view or is not noticeable. For example, the missing item may be covered by or hidden behind another item, or the individual is unable to remember the location of where the missing item was previously placed. As another example, an individual who is travelling can misplace the items in his/her hotel room or other temporary residence, and it would be very disadvantageous for the traveler to misplace particular items.

Most items do not have location indicators. In a current technology, an article locator provides a one-way communication to a target item for purposes of detecting the target item. However, this current technology is bulky, cumbersome, limited in capabilities by providing only a one-way communication to detect a target item, and impractical for an individual who misplaces multiple items.

Therefore, the current technology is limited in its capabilities and suffers from at least the above constraints and deficiencies.

### SUMMARY

In one embodiment of the invention, an apparatus for locating devices comprises a two-way locator comprising a first locator removably coupled to a first item and a second locator coupled to a second item. The first locator is configured to transmit a first trigger signal, the second locator is configured to receive the first trigger signal, and the second locator is configured to generate at least one location indicator signal in response to the first trigger signal. The second locator is configured to transmit a second trigger signal, the first locator is configured to receive the second trigger signal, and the first locator is configured to generate at least one location indicator signal in response to the second trigger signal.

In another embodiment of the invention, an apparatus for locating devices comprises a two-way locator means comprising a first locator means for transmitting a first trigger signal and for generating at least one location indicator signal in response to a second trigger signal and a second locator means for transmitting the second trigger signal and for generating at least one location indicator signal in response to the first trigger signal.

In yet another embodiment of the invention, a method comprises: transmitting, from a first locator, a first trigger signal; receiving, by a second locator, the first trigger signal; and generating, by the second locator, at least one location indicator signal in response to the first trigger signal.

It is to be understood that both the foregoing general description and the following detailed description are exemplary and explanatory only and are not restrictive of the invention, as claimed.

The accompanying drawings, which are incorporated in and constitute a part of this specification, illustrate one (several) embodiment(s) of the invention and together with the description, serve to explain the principles of the invention.

### BRIEF DESCRIPTION OF THE DRAWINGS

Non-limiting and non-exhaustive embodiments of the invention are described with reference to the following figures, wherein like reference numerals refer to like parts throughout the various views unless otherwise specified.

FIG. 1 is a block diagram of an example system (or example apparatus or two-way locator) that includes an embodiment of the invention.

FIG. 2 is a block diagram of the two-way locators, in accordance with an embodiment of the invention.

FIG. 3 is a block diagram of a locator, in accordance with another embodiment of the invention.

FIG. 4 is a method in accordance with an embodiment of the invention.

### DETAILED DESCRIPTION OF PREFERRED EMBODIMENTS

In the description herein, numerous specific details are provided, such as examples of components, parts, structures, and/or methods, to provide a thorough understanding of embodiments of the invention. One skilled in the relevant art will recognize, however, that an embodiment of the invention can be practiced without one or more of the specific details, or with other apparatus, systems, methods, components, materials, parts, structures, and/or the like. In other instances, well-known structures, materials, or operations are not shown or described in detail to avoid obscuring aspects of embodiments of the invention. Additionally, the figures are representative in nature and their shapes are not intended to illustrate the precise shape or precise size of any element and are not intended to limit the scope of the invention.

Those skilled in the art will understand that when an element or part in the drawings is referred to as being “on” (or “coupled” to or “attached” to) another element, it can be directly on (or attached to) the other element or intervening elements may also be present. Furthermore, relative terms such as “inner”, “outer”, “upper”, “above”, “lower”, “beneath”, and “below”, and similar terms, may be used herein to describe a relationship of one element or another element. It is understood that these terms are intended to encompass different orientations of the device in addition to the orientation depicted in the figures.

Although the terms first, second, and the like may be used herein to describe various elements, components, regions, layers and/or sections, these elements, components, parts, regions, layers, and/or sections should not be limited by these terms. These terms are only used to distinguish one element, component, part, region, layer, or section from another component, part, region, layer, or section. Thus, a first element, component, part, region, layer, or section discussed below could be termed a second element, component, part region, layer, or section without departing from the teachings of the present invention.

Embodiments of the invention are described herein with reference to various view illustrations that are schematic illustrations of representative embodiments of the invention. As such, variations from the shapes of the illustrations as a result, for example, of manufacturing techniques and/or tolerances are expected. Embodiments of the invention should not be construed as limited to the particular shapes of the components illustrated herein but are to include deviations in shapes that result, for example, from manufacturing or particular implementations. An element illustrated or described as square or rectangular may typically have rounded or curved features due to normal manufacturing tolerances or due to a particular implementation. Thus, the elements illustrated in the figures are schematic in nature and their shapes are not intended to illustrate the precise shape of an element of a device and are not intended to limit the scope of the invention.

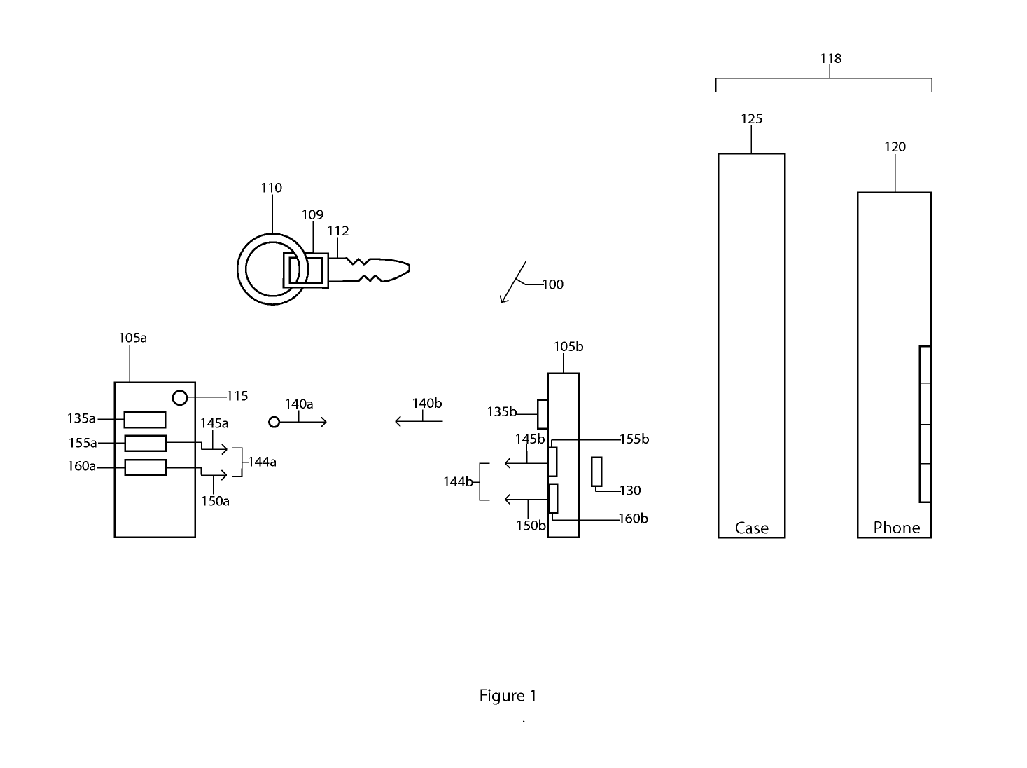

FIG. 1 is a block diagram of an example system 100 (or example apparatus 100 or two-way locator 100) that includes an embodiment of the invention. Embodiments of the invention allow for the speedy location and recovery of a misplaced item. The misplaced item can be within a reasonable range from the individual. For example, the misplaced item can be, for example, without limitations, up to or greater than 100 feet from the location of the individual. As another example, the misplaced item is near or is adjacent to the location of the individual, but is out of the sight of (or is un-noticed) by the individual who is searching for the misplaced item.

An apparatus 100 (or two-way locator 100) in accordance with an embodiment of the invention includes a first locator 105a and a second locator 105b that is associated with the first locator 105a. As will be discussed below, the locators 105a and 105b engage in a two-way communication, so that the first locator 105a is used to detect the location of the locator 105b and the locator 105b is similarly used to detect the location of the locator 105a. Therefore, the first locator 105a is usable for locating the second locator 105b, and the second locator 105b is usable for locating the first locator 105a.

In an embodiment of the invention, the locators 105a and 105b are packaged in a durable material so that the components and circuitry in the locators 105a and 105b are sufficiently protected from damage. One example of a durable material is a light-weight durable plastic or other conventional durable synthetic materials.

The locator 105a is removably coupled to a first item 109 (which can be a key ring 110 or key 112). The key ring 110 is inserted into a hole (opening) 115 of the locator 105a. Two components that are removably coupled (or removably attached or removably secured or removably connected) means that the two different components can be attached together and detached apart. One or more keys 112 (e.g., residence key and/or car key) is also removably coupled to the key ring 110.

The locator 105b is coupled to a second item 118 (which can be a portable communication device 118 such as, e.g., a portable phone 120 or a portable communication device case 125 for storing a phone or other portable device 120). The locator 105b can alternatively be removably coupled to the second item 118. The portable phone 120 is, for example, a cellular phone or another type of portable communication device such as a personal digital assistant (PDA) (or other portable devices) which may have the phone-call functionalities of a cellular phone. It is understood by those skilled in the art that the phone 120 and case 125 can have various shapes and configurations. For ease of discussion, the phone 120 and case 125 are shown in FIG. 1 in a simplified example rectangular shape.

The locator 105b is coupled to (or removably coupled to) the phone 120 or case 125 by an attachment mechanism 130. For example, the attachment mechanism can be a Velcro attachment mechanism, a high strength magnet attachment mechanism, a snap-on attachment mechanism, a permanent attachment mechanism, or another suitable type of attachment device that will securely attach the locator 105b to the phone 120 or case 125.

The locator 105a and locator 105b are remote from each other. Those skilled in the art will realize that the term “remote” means that a component is physically separated from another component, but both components are capable of communicating with each other as will be described in the examples below.

As an example operation, assume that the individual has his/her key 112 and key chain 110 in his/her possession. Since the locator 105a is attached to the key ring 110, the individual will also have the locator 105a in his/her possession. Assume that the individual has misplaced his/her portable phone 120 (or has misplaced a case 125 which holds the phone 120). The individual can press (or select) a first actuator 135a on the locator 105a in order to detect the presence or location of the missing phone 120 (or missing case 125 which holds the phone 120) because the second locator 105b is coupled (or removably coupled) to the phone 120 or to the case 125. The actuator 135a can be, for example, a button, a touch-screen selection button, or another user interface mechanism that allows the individual to initiate an operation of the locator 105a by pressing or selecting the actuator 135a. By pressing the actuator 135a, a transmission of a first trigger signal 140a from locator 105a is initiated or triggered.

When the individual presses the actuator 135a in the first locator 105a, the locator 105a will transmit the trigger signal 140a that is received by the second locator 105b. The trigger signal 140a can be, for example, without limitations, a radio frequency signal or other types of communication signals such as optical signals, laser signals, infrared signals, ultrasonic signals, ultraviolet signals, low frequency type communication signals, or other suitable communication signals. The details of the components and circuitry in an embodiment of the locators 105a and 105b are discussed further below.

In response to receiving the trigger signal 140a, the second locator 105b will emit at least one location indicator signal 144b which can include, for example, a visual indicator signal 145b and/or an audio indicator signal 150b. The location indicator signals 144a can include, for example, the visual indicator signal 145a and/or audio indicator signal 150a.

The visual indicator signal 145b can be, for example, an optical signal such as a light signal that is emitted from a visual interface 155b and that is noticeable to the individual who is using the locator 135a. The visual interface 155b can be, for example, without limitations, a light emitting diode (LED), a laser source, a light bulb or other optical device, or any suitable optical interface that can emit an optical signal that will be detectable by or noticeable to the user of the locator 105a.

The audio indicator signal 150b can be, for example, an audible sound that is emitted from an audio interface 160b. Such audible sounds can be, for example, a buzzer sound, recorded human voice, recorded music, bell sounds, or any suitable audio signal that is noticeable to the individual who is using the locator 105a. The audio interface 160b can be, for example, without limitations, a speaker or any suitable audio interface that can emit an audio signal that will be detectable by or noticeable to the user of the locator 105a. Therefore, the visual signal 145b and/or audio signal 150b permits the user of the locator 105a to determine the location of the missing items 120 and/or 125.

As another example, assume that the individual has the phone 120 and/or case 125 in his/her possession. Since the locator 105b is attached to the phone 120 (if a case 125 is not used to store the phone 120) or to the case 125 (if the case 125 is used to store the phone 120), the individual will also have the locator 105b in his/her possession. Assume that the individual has misplaced his/her key 112. The individual can press (or select) an actuator 135b on the locator 105b in order to detect the presence or location of the missing item of the key 112 in this example because the first locator 105a is removably coupled to the key chain 110 which also holds the key 112. The actuator 135b can be, for example, a button, a touch-screen selection button, or another user interface mechanism that allows the individual to initiate an operation of the locator 105b by pressing or selecting the actuator 135.

When the individual presses the actuator 135b in the second locator 105b, the locator 105b will transmit a second trigger signal 140b that is received by the first locator 105a. As similarly discussed above, the trigger signal 140b can be, for example, without limitations, a radio frequency signal or other types of communication signals such as optical or laser signals, infrared signals, ultrasonic signals, ultraviolet signals, low frequency type communication signals, or other suitable communication signals.

In response to receiving the trigger signal 140b, the first locator 105a will emit a visual indicator signal 145a from the visual interface 155a and/or an audio indicator signal 150a from the audio interface 160a, as similarly discussed above. Therefore, the visual signal 145a and/or audio signal 150a permits the user of the locator 105b to determine the location of the missing item 109.

In an embodiment of the invention, the locators 105a and 105b provide easy-to-use devices for the consumer. The consumer can determine the location of a missing item (attached to a locator) by pushing, clicking, or selecting an actuator on another locator in the possession of the consumer. Therefore, the locators 105a and 105b provide a two-way locator for locating devices such as keys or phones or other common items used by individuals. One locator (e.g., locator 105a) can be used to determine the location of the other locator (e.g., locator 105b) and vice versa. Therefore, the locators 105a and 105b permit an individual to quickly locate a misplaced or missing item. The locators 105a and 105b would also advantageously improve or upgrade items that individuals currently purchase such as portable phone cases or key chains because the locators 105a and 105b would minimize the misplacement of these commonly-used items. If individual has the key(s) in hand and has misplaced the cellular phone (or, alternatively, the individual has the cellular phone in hand and has misplaced the key), then the key can be used to locate the misplaced portable phone or the portable phone (or phone case) can be used to locate the misplaced key by use of the above-discussed locators 105a and 105b.

Additionally, the locators 105a and 105b would beneficially simplify the daily life of individuals, would lessen inconvenience, would lessen the time consumed for looking for misplaced items, and would lessen the worries for individuals. Furthermore, standard components that are commercially available as “off-the-shelf” components, customizable components, or miniaturized components can be leveraged for ease of manufacture, decrease in size or bulk of the locators 105a/105b, and provide aesthetic appeal for embodiments of the invention. Customizable components can also potentially decrease the size and bulk of the locators 105a/105b.

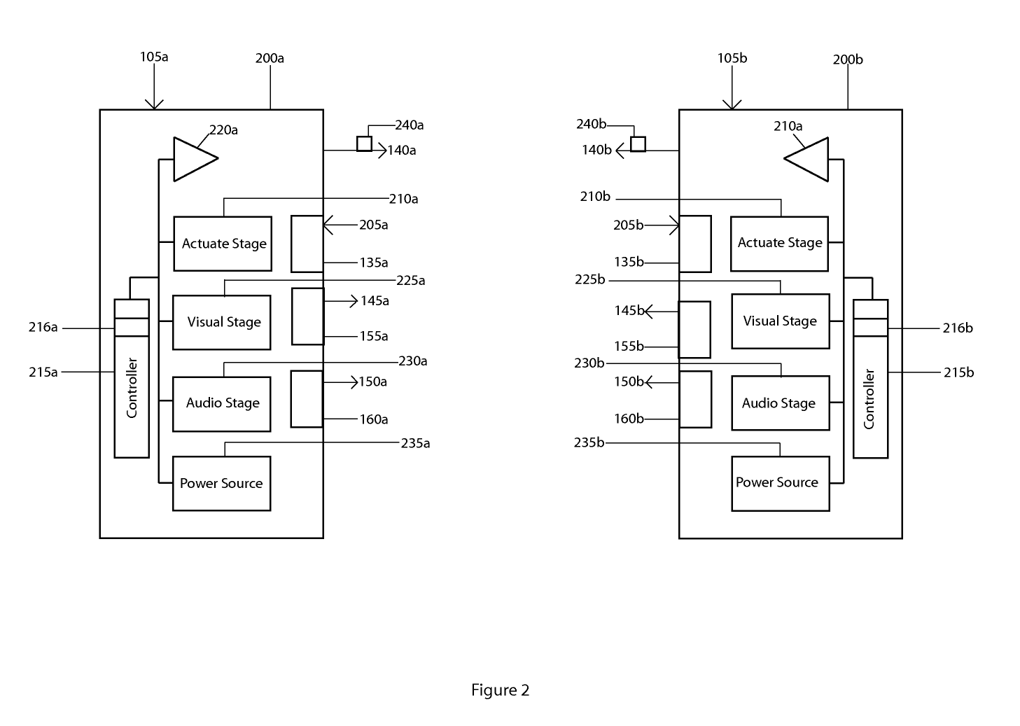

FIG. 2 is a block diagram of the two-way locators 105a and 105b, in accordance with an embodiment of the invention. The components and circuitry in the locators 105a and 105b are provided by the baseline technology 200a and 200b, respectively. The baseline technologies 200a and 200b are, for example, without limitations, circuit boards with components, wirings, traces, semiconductor elements, and/or other electrical/electronic elements. Alternatively, the baseline technologies 200a and 200b can be programmable logic devices (PLDs) such as, for example, field programmable gate arrays (FPGAs) or PLDs in combination with other electrical/electronic elements. Alternatively, the baseline technologies 200a and 200b can be nano-technology based elements or nano-technology based elements in combination with other electrical/electronic elements, or other suitable technologies that may be developed as knowledge advances. For ease of discussion, known electrical/electronic elements such as, for example, conductors, relays, switches, transistors, LEDs, and/or other elements are not shown in FIG. 2.

When the individual presses (selects) 205a the first actuator 135a in the first locator 105a, the first actuator stage 210a detects the pressing (or selection) of the actuator 135a and sends a signal to the controller 215a to indicate the pressing of the actuator 135a. In response to the signal from the actuator stage 210a, the controller 215a will trigger the transmitter component (of the transceiver 220a) to transmit the trigger signal 140a. In another embodiment of the invention, the transceivers 220a and 220b in the locators 105a and 105b, respectively, can be embodied as separate transmitter and receiver components. The trigger signal 140a can be, for example, a code of a certain bit size (e.g., 40 bits or less). Controllers and transceivers are commercially available from various vendors. The controller 215a can store the code bits in a memory 216a which can be integrated with the controller 215a or can be a separate memory that is accessible to the controller 215a. Similarly, the controller 215b has access to a memory 216b.

The receiver component of the transceiver 220b (in the remote locator 105b) receives the trigger signal 140a. The controller 215b processes the received trigger signal 140a. In response to the received trigger signal 140a, the controller 215b will actuate the visual stage 225b so that the visual stage 225b will send a control signal that will cause the visual interface 155b to generate the visual indicator signal 145b.

In response to the received trigger signal 140a, the controller 215b will additionally or alternatively actuate the audio stage 230b so that the audio stage 230b will send a control signal that will cause the audio interface 160b to generate the audio signal 150b. The visual stage 225a and audio stage 230a (in locator 105a) also function as similarly discussed above. Typically, the visual stages 225a/225b and audio stages 230a/230b are control circuits that generate control signals in response to control signals from a controller, so that the optical interfaces 155a/155b and audio interfaces 160a/160b will generate the above discussed visual indicator signals 145a/145b or audio indicators signals 150a/150b. A variety of control circuits for generating desired control signals are well-known to those skilled in the art. Additionally, the power sources 235a and 235b can be used to provide power to the components in the locators 105a and 105b, respectively.

Similarly, in another example, when the individual presses (selects) 205b the actuator 135b in the second locator 105b, the actuator stage 210b detects the pressing (or selection) of the actuator 135b and sends a signal to the controller 215b to indicate the pressing of the actuator 135b. In response to the signal from the actuator stage 210b, the controller 215b will trigger the transmitter component (of the transceiver 220b) to transmit the trigger signal 140b.

The receiver component of the transceiver 220a (in the remote locator 105a) receives the trigger signal 140b. The controller 215a processes the received trigger signal 140b. In response to the received trigger signal 140b, the controller 215a will actuate the visual stage 225a so that the visual stage 225a will send a control signal that will cause the visual interface 155a to generate the visual indicator signal 145a.

In response to the received trigger signal 140b, the controller 215a will additionally or alternatively actuate the audio stage 230a so that the audio stage 230a will send a control signal that will cause the audio interface 160a to generate the audio signal 150a.

In another embodiment of the invention, the actuator 135a (of locator 105a) permits the user to select if he/she wants the remote locator 105b to emit any of the following response signals: (1) only optical signals 145b, (2) only audio signals 150b, or (3) both optical signals 145b and audio signals 150b. The actuator stage 210 determines if the user selected any of the above response signals to be sent from the remote locator 105b and sends an appropriate control signal to the controller 215a. The controller 215a then causes the transceiver 220a to transmit the trigger signal 140a with the function code 240a (which can be a code in the code bits of the trigger signal 140a). The transceiver 220b receives this trigger signal 140a with the function code 240a. Based on the function code 240a, the controller 215b can control the visual stage 225b and audio stage 230b to generate the response signal that was desired by the user of locator 105a. Similarly, the user can use the actuator 135b to select the desired response signal from the locator 105a. The controller 215b will include the function code 240b in the trigger signal 140b as similarly discussed above. However, in another embodiment of the invention, the use of the function codes 240a and 240b are omitted. As known to those skilled in the art, function codes and 40-bit transmitting codes are used in the one-way communication scheme that is used for remote keyless entry systems of current automobile technology.

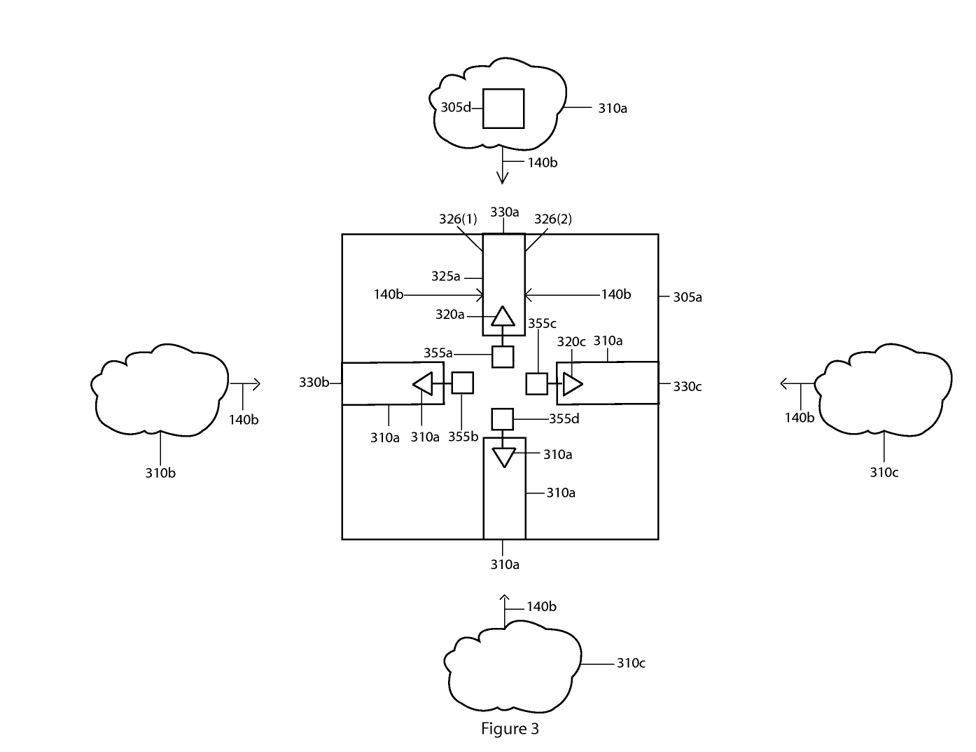

FIG. 3 is a block diagram of a locator 305a, in accordance with another embodiment of the invention. A remote locator 305b is also shown in a first location 310a with respect to the locator 305a and is not drawn to scale for ease of discussion. The locators 305a and 305b have similar components and may also include the various above-discussed components that are not shown in FIG. 3 for ease of discussion. These various above-discussed components that can be included in the locators 305a and 305a are, for example, the actuators, actuator stages, visual stages, audio stages, audio interfaces, controllers, and/or power sources, as discussed above. Of course, the locators 305a and 305b will include essential components that are required for functionality such as, for example, power sources, controllers, actuators, and transceivers.

For ease of discussion, only the locator 305a will be discussed in detail. It is understood that the locator 305b can have similar functionalities and components as the locator 305a. In an embodiment of the invention, the locator 305a has a directional indicator capability to indicate the location or general direction of the remote locator 305b, and this location will be indicative of the location of the misplaced item (e.g., key or phone or phone with case).

In an embodiment of the invention, the locator 305a includes the transceivers 320a, 320b, 320c, and 320d, where the first transceiver 320a and the second transceiver 320d are opposite to each other in the locator 305a and the transceivers 320b and 320c are opposite to each other in the locator 305b. In another embodiment of the invention, the transceivers 320b and 320c are omitted.

In an embodiment of the invention, the transceiver 320a is disposed within a shield 325a which has the shield walls 326(1) and 326(2) that blocks the trigger signal 140a from reaching the transceiver 320a. Therefore, the transceiver 320a detects the trigger signal 140a only if the trigger signal 140a enters the opening 330a of the shield 325a. Therefore, the transceiver 320a will only detect the trigger signal 140a that comes from the first location 310a which is approximately opposite in location from the opening 330a. In response to the trigger signal 140a transmitting through the opening 330a, the visual indicator 355a will light up or turn on. The controller 215a (e.g., FIG. 2) will send a control signal to the visual stage 225a (FIG. 2) that causes the visual stage 225a to turn on the visual indicator 355a which is adjacent to the opening 330a that received the trigger signal 140b from location 310a. As a result, the user of the locator 305a will realize that the remote locator 305b is located in the direction of location 310a which is approximately opposite to the opening 330a. The visual indicators 355a-355d will, therefore, indicate the location or direction of the location of the remote locator 305b.

Similarly, in response to the trigger signal 140a transmitting through the opening 330b of shield 325b, the visual indicator 355b will light up or turn on. As a result, the user of the locator 305a will realize that the remote locator 305b is located in the direction of location 310b which is approximately opposite to the opening 330b.

Similarly, in response to the trigger signal 140a transmitting through the opening 330c of shield 325c, the visual indicator 355c will light up or turn on. As a result, the user of the locator 305a will realize that the remote locator 305b is located in the direction of location 310c which is approximately opposite to the opening 330c.

Similarly, in response to the trigger signal 140a transmitting through the opening 330d of shield 325d, the visual indicator 355d will light up or turn on. As a result, the user of the locator 305a will realize that the remote locator 305b is located in the direction of location 310d which is approximately opposite to the opening 330d.

Various materials can be used for the shields 325a-325d to block the trigger signals 140b. For example, if the trigger signal 140b is radio frequency (RF) signal, then the walls 326(1) and 326(2) can be metal or can be non-metal materials with metal particulates, metal paint, or metal coatings, so that the walls 326(1)/326(2) can substantially block the RF signals from transmitting to the transceiver 320a. It is understood that the composition of the blocking materials in the walls of the shields 325a-325d can depend on the type of signal that is transmitted by the locators 310a and 310b.

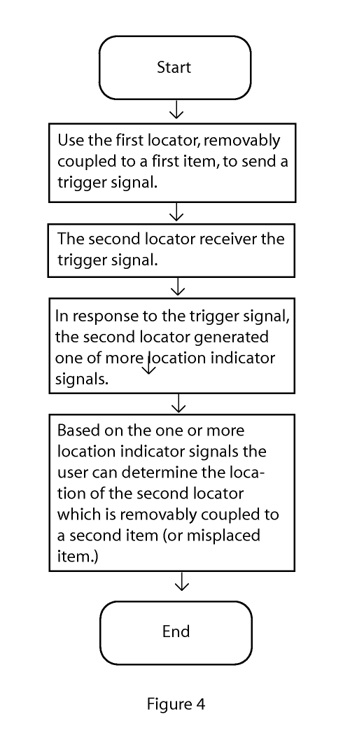

FIG. 4 is a method 400 in accordance with an embodiment of the invention. In block 405, the user will use the first locator, which is coupled (or removably coupled) to a first item, to send a trigger signal. The first item can be, for example, a key or a portable communication device such as a cellular phone.

In block 410, the second locator receives the trigger signal. In block 415, in response to the trigger signal, the second locator generates at least one location indicator signal (i.e., one or more location indicator signals). As discussed above, the location indicator signals can be a visual signal 145a or 145b and/or an audio signal 150a or 150b. In block 415, the first locator can also indicate the location of the second locator.

In block 420, based on the at least one location indicator signal (i.e., one or more location indicator signals), the user can determine the location of the second locator which is coupled (or removably coupled) to a second item (or misplaced item).

Other variations and modifications of the above-described embodiments and methods are possible in light of the teaching discussed herein.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

What is claimed is:

1. An apparatus for locating devices, the apparatus comprising:
a two-way locator comprising a first locator removably coupled to a first item and a second locator coupled to a second item;
wherein the first locator is configured to transmit a first trigger signal, wherein the second locator is configured to receive the first trigger signal, and wherein the second locator is configured to generate at least one location indicator signal in response to the first trigger signal;
wherein the second locator is configured to transmit a second trigger signal, wherein the first locator is configured to receive the second trigger signal, and wherein the first locator is configured to generate at least one location indicator signal in response to the second trigger signal.

2. The apparatus of claim 1, wherein the first item comprises a key and the second item comprises a portable communication device.

3. The apparatus of claim 1 wherein the first item comprises a key and the second item comprises a portable communication device case.

4. The apparatus of claim 1, wherein the first locator comprises a first transceiver configured to transmit the trigger signal and to receive the second trigger signal and wherein the second locator comprises a second transmitter configured to transmit the second trigger signal and to receive the first trigger signal.

5. The apparatus of claim 1, wherein the at least one location indicator signal comprises a visual signal.

6. The apparatus of claim 1, wherein the at least one location indicator signal comprises an audio signal.

7. The apparatus of claim 1 wherein the first locator is usable for locating the second locator and the second locator is usable for locating the first locator.

8. The apparatus of claim 1, wherein the first locator comprises a location indicator that indicates a location of the second locator.

9. The apparatus of claim 8, wherein the second locator comprises another location indicator that indicates a location of the first locator.

10. The apparatus of claim 1, wherein the first locator comprises a first transceiver configured to receive a first trigger signal from a first location and a second transceiver configured to receive a second trigger signal from a second location.

11. The apparatus of claim 10, further comprising a first shield and a second shield;
wherein the first transceiver is disposed within the first shield and wherein the second transceiver is disposed within the second shield.

12. The apparatus of claim 1, wherein the first locator comprises a first actuator for triggering a transmission of a first trigger signal and wherein the second locator comprises a second actuator for triggering a transmission of a second trigger signal.

13. An apparatus for locating devices, the apparatus comprising:
a two-way locator means comprising a first locator means for transmitting a first trigger signal and for generating at least one location indicator signal in response to a second trigger signal and a second locator means for transmitting the second trigger signal and for generating at least one location indicator signal in response to the first trigger signal.

14. The apparatus of claim 13, wherein the first item comprises a key and the second item comprises a portable communication device.

15. The apparatus of claim 13 wherein the first item comprises a key and the second item comprises a portable communication device case.

16. The apparatus of claim 13, wherein the first locator means comprises a first transceiver means for transmitting the trigger signal and for receiving the second trigger signal and wherein the second locator means comprises a second transmitter means for transmitting the second trigger signal and for receiving the first trigger signal.

17. The apparatus of claim 13, wherein the first locator means comprises a location indicator means for indicating a location of the second locator.

18. The apparatus of claim 17, wherein the second locator means comprises another location indicator means for indicating a location of the first locator.

19. A method comprising:
transmitting, from a first locator, a first trigger signal;
receiving, by a second locator, the first trigger signal; and
generating, by the second locator, at least one location indicator signal in response to the first trigger signal.

20. The method of claim 19, further comprising:
transmitting, from the second locator, a second trigger signal;
receiving, by the first locator, the second trigger signal; and
generating, by the first locator, at least one location indicator signal in response to the second trigger signal.
